(19) United States
(12) Patent Application Publication
(10) Pub. No.: US 2025/0385418 A1
(43) Pub. Date: Dec. 18, 2025

(54) CONVERTER

(71) Applicant: Proterial, Ltd., Tokyo (JP)

(72) Inventors: Takahiro SUGIYAMA, Tokyo (JP); Kazuhiro ABE, Tokyo (JP)

(73) Assignee: Proterial, Ltd., Tokyo (JP)

(21) Appl. No.: 19/225,469

(22) Filed: Jun. 2, 2025

(30) Foreign Application Priority Data
Jun. 14, 2024 (JP) 2024-096635

(51) Int. Cl. H01P 5/08; H01P 3/06; H01P 3/16; H01Q 13/18

(52) U.S. Cl. CPC H01P 5/087; H01P 3/06; H01P 3/16; H01Q 13/18

(57) ABSTRACT

A converter for electromagnetically coupling a dielectric waveguide and a coaxial line, includes a shaft-shaped waveguide member composed of a dielectric having a conical-shaped portion at one end in an axial direction, an antenna arranged opposite a conical surface of the conical-shaped portion, a housing for housing the waveguide member and the antenna, and a support member for supporting the waveguide member against the housing, wherein the coaxial line is connected to the antenna, while the dielectric waveguide is connected to the waveguide member, wherein the support member supports the waveguide member against the housing by contacting one part of a circumferential portion of an outer circumferential surface of the waveguide member, and wherein a gap is formed between an other part of a circumferential part of an outer circumferential surface of the waveguide member, which the support member does not contact, and an inner surface of the housing.

### CROSS-REFERENCE TO RELATED APPLICATIONS

The present patent application claims the priority of Japanese patent application No. 2024-096635 filed on Jun. 14, 2024, and the entire contents thereof are hereby incorporated by reference.

### TECHNICAL FIELD

The present invention relates to a converter for converting the transmission medium of electromagnetic waves by electromagnetically coupling a dielectric waveguide and a coaxial line.

### BACKGROUND TECHNOLOGY

Conventionally, some transmission lines for transmitting high-frequency signals are composed of multiple different transmission components coupled together. For example, Patent Literature 1 describes a coaxial waveguide converter that couples a coaxial line and a waveguide. The applicant of the present invention has also proposed a dielectric waveguide described in Patent Literature 2 as a waveguide with excellent flexibility that can transmit electromagnetic waves in a quasi-millimeter wave band or a millimeter wave band with low loss. The dielectric waveguide described in Patent Literature 2 has a core composed of a plurality of dielectric waveguide wires bundled together, each of which is composed of a dielectric material made of a resin such as fluoroplastic, and an outer coating that covers the core.

### CITATION LIST

### Patent Literatures

Patent Literature 1: JP2006-157486A
Patent Literature 2: JP2023-169959A

### SUMMARY OF THE INVENTION

In a transmission line that transmits high-frequency signals, it is assumed that a dielectric waveguide and a coaxial line are coupled. Therefore, the object of the present invention is to provide a converter that is capable of coupling a dielectric waveguide and a coaxial line with low loss.

For the purpose of solving the above problem, one aspect of the present invention provides A converter for electromagnetically coupling a dielectric waveguide and a coaxial line, comprising:
a shaft-shaped waveguide member composed of a dielectric having a conical-shaped portion at one end in an axial direction;
an antenna arranged opposite a conical surface of the conical-shaped portion;
a housing for housing the waveguide member and the antenna; and
a support member for supporting the waveguide member against the housing,
wherein the coaxial line is connected to the antenna, while the dielectric waveguide is connected to the waveguide member,
wherein the support member supports the waveguide member against the housing by contacting one part of a circumferential portion of an outer circumferential surface of the waveguide member, and
wherein a gap is formed between an other part of a circumferential part of an outer circumferential surface of the waveguide member, which the support member does not contact, and an inner surface of the housing.

### Advantageous Effects of the Invention

According to the converter of the present invention, it is possible to provide a converter that is capable of coupling a dielectric waveguide and a coaxial line with low loss.

### BRIEF DESCRIPTION OF DRAWINGS

FIG. 1A is a configuration diagram showing a part of a transmission line including a converter according to an embodiment of the present invention.

FIG. 1B is a cross-sectional view of the coaxial line of the transmission line.

FIG. 2A is a perspective view showing a configuration example of a dielectric waveguide.

FIG. 2B is a cross-sectional view of the dielectric waveguide.

FIG. 3 is a six-sided view showing the exterior of the converter.

FIG. 4A is a cross-sectional view in the axial direction of the converter taken along the line A-A in FIG. 3.

FIG. 4B is a partial cross-sectional view of one end of the dielectric waveguide connected to the converter.

FIG. 4C is a cross-sectional view of the converter combined with the dielectric waveguide.

FIG. 5A is an end view of one end face of the converter in the axial direction with the coaxial connector omitted.

FIG. 5B is a cross-sectional view of the converter taken along the line B-B in FIG. 3.

FIG. 5C is a cross-sectional view of the converter taken along the line C-C in FIG. 3.

FIG. 5D is a cross-sectional view of the converter taken along the line D-D in FIG. 3.

FIG. 6A is a cross-sectional view of the converter taken along the line E-E in FIG. 3, showing the inside of the housing, omitting the second housing member.

FIG. 6B is an external view of a coaxial connector viewed from the same direction as in FIG. 6A.

FIG. 6C is a plan view of a tapered slot antenna viewed from the same direction as in FIG. 6A.

FIG. 7A is a perspective view of the tapered slot antenna.

FIG. 7B and FIG. 7C are explanatory diagrams illustrating the electromagnetic waves radiated from the tapered slot antenna.

FIG. 8A is a three-sided view showing the configuration of the converter according to a comparative example.

FIG. 8B is a cross-sectional view of the converter taken along the line F-F in FIG. 8A.

FIG. 9A is a graph showing the results of measuring S21 of S-parameters for the case of using the converter in Example according to the embodiment and the case of using the converter in the comparative example, respectively.

FIG. 9B is a graph showing the results of measuring S11 of S-parameters for the case of using the converter in Example according to the embodiment and the case of using the converter in the comparative example, respectively.

### DETAILED DESCRIPTION OF THE INVENTION

### Embodiment

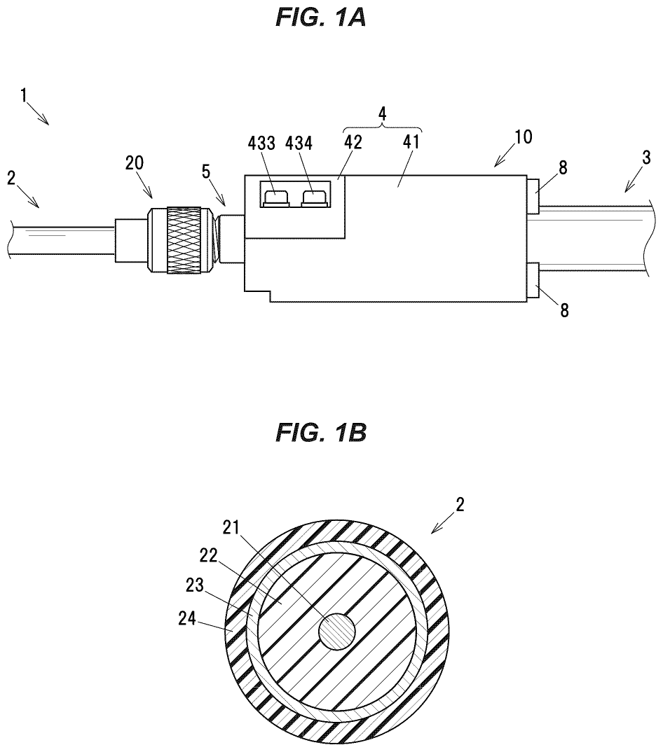

FIG. 1A is a configuration diagram showing a part of a transmission line 1 including a converter 10 according to an embodiment of the present invention. The transmission line 1 has a coaxial line 2, a dielectric waveguide 3, and a converter 10 that electromagnetically couples the coaxial line 2 and the dielectric waveguide 3 to transmit electromagnetic waves in the GHz band. The converter 10 propagates electromagnetic waves that have propagated through the coaxial line 2 into the dielectric waveguide 3. The transmission line 1 is particularly suitable for transmission of electromagnetic waves from 20 GHz to 100 GHz (20 GHz or more and 100 GHz or less), but can also be used for transmission of electromagnetic waves from 100 GHz to 300 GHz (100 GHz or more and 300 GHz or less).

FIG. 1B is a cross-sectional view of the coaxial line 2. The coaxial line 2 has a center conductor wire 21, a dielectric 22 surrounding the center conductor wire 21, an outer conductor wire 23 covering the dielectric 22, and a sheath 24 covering the outer conductor wire 23. The center conductor wire 21 is a single wire made of, e.g., copper or a copper alloy. The outer conductor wire 23 is made of, e.g., a braided wire or a conductive tape. The coaxial line 2 has a connector 20 at one end, and the connector 20 is connected to a connector 5 of the converter 10.

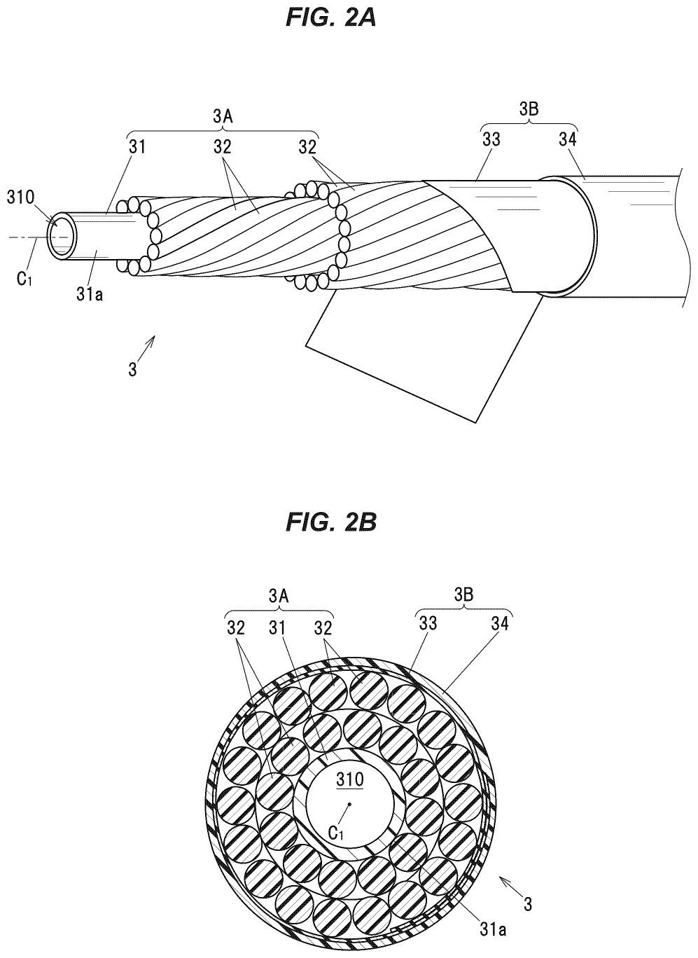

FIG. 2A is a perspective view showing a configuration example of a dielectric waveguide 3. FIG. 2B is a cross-sectional view of the dielectric waveguide 3. In FIG. 2A, an edge of the dielectric waveguide 3 is shown stripped in steps. In FIG. 2A, a central axis C₁ of the dielectric waveguide 3 is shown as a dashed-dotted line.

The dielectric waveguide 3 has a core 3A that is a waveguide made of a dielectric material, and a jacket 3B provided around a outer circumference of the core 3A. The core 3A is composed of a dielectric waveguide tube 31 and a plurality of dielectric waveguide wires 32 arranged around the dielectric waveguide tube 31. The dielectric waveguide tube 31 is a hollow tube with a cavity 310 formed at the center. The plurality of dielectric waveguide wires 32 are twisted into a spiral shape at an angle to the longitudinal direction of the dielectric waveguide 3. This configuration of the core 3A enhances the flexibility of the dielectric waveguide 3.

The dielectric that constitutes the core 3A is a resin whose dielectric loss tangent (i.e., dissipation factor) at the frequency of electromagnetic waves transmitted by the dielectric waveguide 3 is smaller than 1×10⁻³. Here, the dielectric loss tangent (also called tan δ, tangent delta, or tan delta) is an index that indicates the ratio of a portion of the energy that becomes heat when an alternating electric field is applied to a dielectric material, and the smaller the value of the dielectric loss tangent is, the smaller the loss becomes. The cavity 310 of the dielectric waveguide tube 31 is filled with air. Since the dielectric loss tangent of air is lower than that of resin, the loss is reduced by the formation of the cavity 310 at the center of the core 3A. Also, some of the electromagnetic waves transmitted by the dielectric waveguide 3 propagate on the outer surface of the dielectric waveguide 3.

Specifically, the materials of the dielectric waveguide tube 31 and dielectric waveguide wires 32 can be any of fluoropolymer, foamed fluoropolymer, polyethylene, foamed polyethylene, polypropylene, and foamed polypropylene, for example. It is desirable that the material of the dielectric waveguide tube 31 be harder than the material of the dielectric waveguide wires 32 in order to maintain the cylindrical shape of the dielectric waveguide 3, even when it is bent. For example, PTFE (polytetrafluoroethylene) can be suitably used as the material of the dielectric waveguide tube 31, and FEP (ethylene tetrafluoride/hexafluoropropylene copolymer) can be used as the material of the dielectric waveguide wires 32.

As shown in FIGS. 2A and 2B, the core 3A has thirty dielectric waveguide wires 32 twisted in a spiral shape around an outer circumference of one dielectric waveguide tube 31 located at the center, forming a double-layer structure with inner and outer layers. Of the thirty dielectric waveguide wires 32, twelve dielectric waveguide wires 32 which constitute the inner layer are arranged in contact with the outer circumference of the dielectric waveguide tube 31, and eighteen dielectric waveguides which constitute the outer layer are arranged on the outer circumference of the twelve dielectric waveguide wires 32 of the inner layer.

The jacket 3B is composed of a band-shaped binder tape 33 wound around the outer circumference of the core 3A and a sheath 34 covering the binder tape 33. The binder tape 33 is spirally wound around the core 3A so that portions of the tape overlap in its width direction. The binder tape 33 prevents the plurality of dielectric waveguide wires 32 from falling apart in the manufacturing process of the dielectric waveguide 3, and the sheath 34 protects the core 3A and the binder tape 33. Additionally, the sheath 34 is formed by extrusion molding around the outer circumference of the binder tape 33. The jacket 3B may be composed of at least either the binder tape 33 or the sheath 34.

The materials of the binder tape 33 and the sheath 34 may have a dielectric loss tangent value higher than that of the dielectric waveguide tube 31 and the dielectric waveguide wires 32, but it is desirable that they be stronger than the materials of the dielectric waveguide tube 31 and the dielectric waveguide wires 32. The binder tape 33 consists of a sealing tape made of fluoroplastic, such as PTFE. The sheath 34 is made of a fluoropolymer such as FEP, for example, and it is desirable that the material be particularly resistant to abrasion and tear.

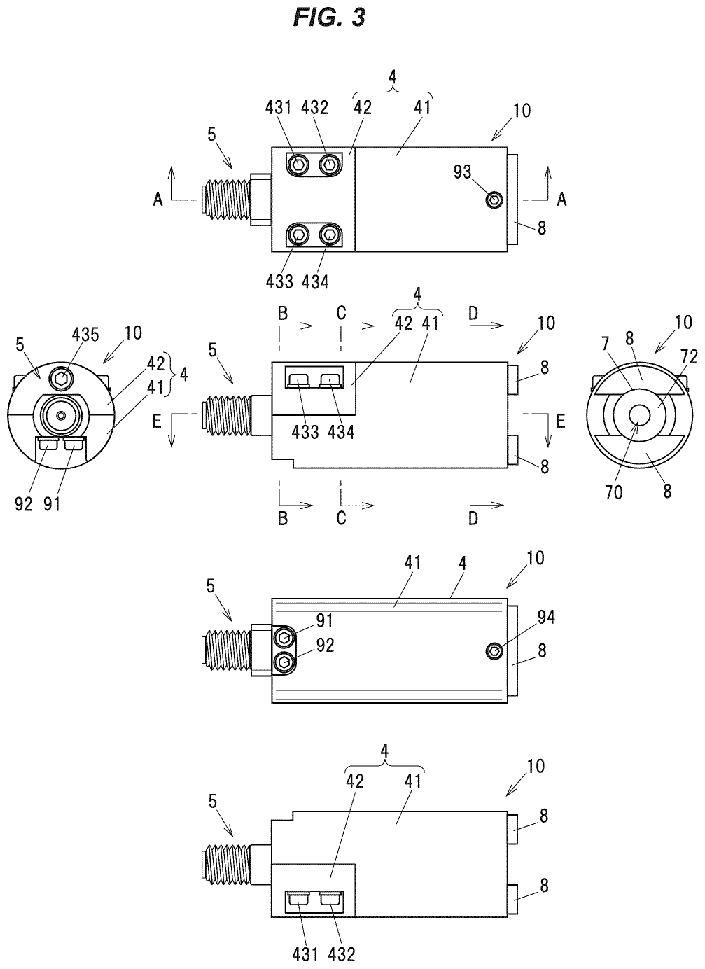

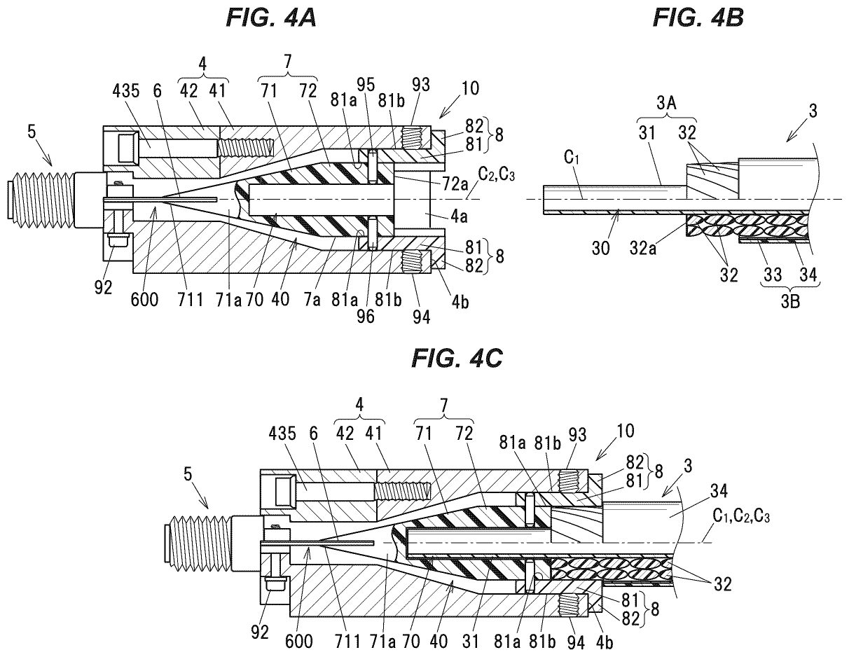

FIG. 3 is a six-sided view showing the converter 10. FIG. 4A is a cross-sectional view of the converter 10 in the axial direction taken along the line A-A in FIG. 3. FIG. 4B is a partial cross-sectional view of one end of the dielectric waveguide 3 connected to the converter 10. FIG. 4C is a cross-sectional view of the converter 10 combined with the dielectric waveguide 3. In FIGS. 4B and 4C, the external appearance of the dielectric waveguide 3 is shown above the central axis C₁ of the dielectric waveguide 3, and a cross-section of the dielectric waveguide 3 is shown below the central axis C₁. At one end of the dielectric waveguide 3, a portion of the dielectric waveguide wires 32 is exposed from the jacket 3B, and furthermore, the dielectric waveguide tube 31 protrudes from an end face 32a of the dielectric waveguide wires 32.

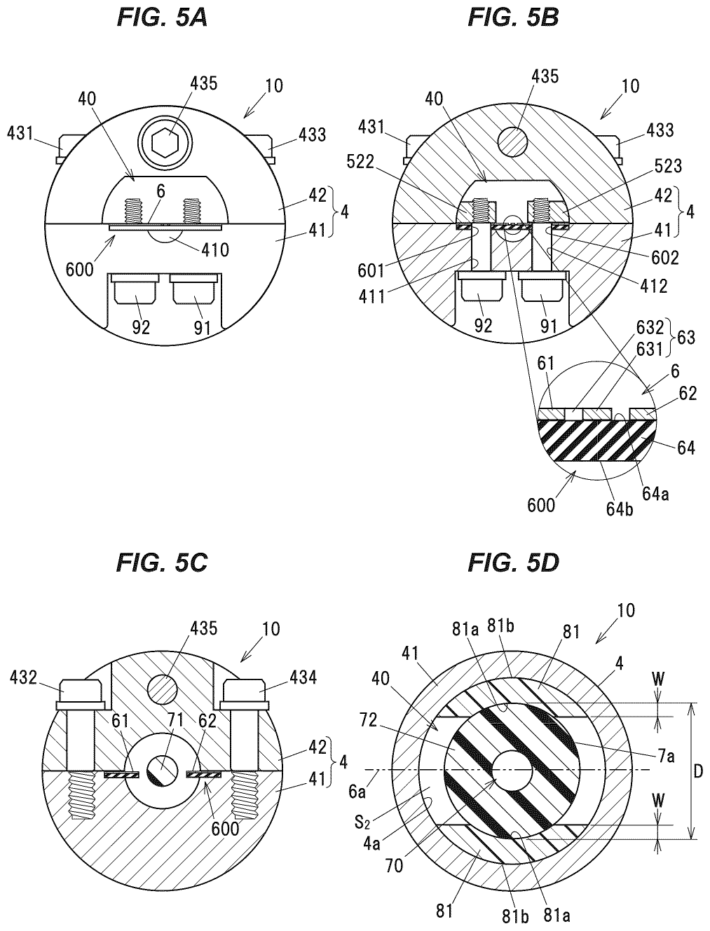

FIG. 5A is an end view of one end face of the converter 10 in the axial direction, omitting the coaxial connector 5. FIG. 5B is a cross-sectional view of the converter 10 perpendicular to the axial direction, taken along the line B-B in FIG. 3. FIG. 5C is a cross-sectional view of the converter 10 perpendicular to the axial direction, taken along the line C-C in FIG. 3. FIG. 5D is a cross-sectional view of the converter 10 perpendicular to the axial direction, taken along the line D-D in FIG. 3.

The converter 10 comprises an electrically conductive housing 4, a coaxial connector 5 attached to one end of the housing 4, a tapered slot antenna 6 secured to the housing 4, a shaft-shaped waveguide member 7 made of a dielectric material and disposed opposite (i.e., to face) the tapered slot antenna 6 in the housing 4, a pair of support members 8 for supporting the waveguide member 7 relative to the housing 4, and a pair of bolts 91, 92 for securing the tapered slot antenna 6 to the housing 4, a pair of set screws 93, 94 for pressing the pair of support members 8 toward the waveguide member 7, and a pair of locating pins 95, 96 for relatively fixing the positions of the waveguide member 7 and the pair of support members 8.

The waveguide member 7 and the support members 8 are made of a dielectric material such as fluoroplastic, specifically PTFE, for example. The housing 4 is in the shape of a cylinder with the central axis C₂ at the center and a cavity 40 formed inside. Hereinafter, the direction parallel to the central axis C₂ is referred to as the “axial direction.” When the dielectric waveguide 3 is combined with the converter 10, the central axis C₁ of the dielectric waveguide 3 coincides with the central axis C₂ of the housing 4.

The housing 4 is composed of a combination of a first housing member 41 and a second housing member 42, and houses the tapered slot antenna 6 and the waveguide member 7. The pair of support members 8 are partially housed in the housing 4 in the axial direction. The first housing member 41 and the second housing member 42 are fastened together by a plurality of bolts 431 to 435. However, the housing 4 may have a one-piece structure by making the first housing member 41 and the second housing member 42 into a single piece. In addition, the housing 4 is made of conductive metal, for example, but not limited to this, it may be made of resin whose entire surface is plated with silver or gold, for example.

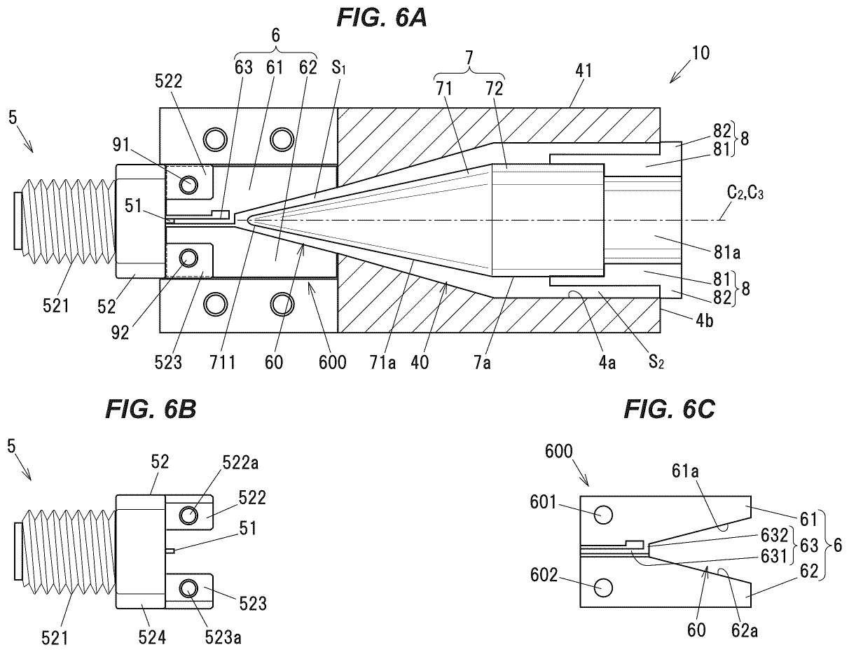

FIG. 6A is a cross-sectional view of the converter taken along the line E-E in FIG. 3, showing the inside of the housing 4, omitting the second housing member 42. FIG. 6B is an external view of the coaxial connector 5 viewed from the same direction as in FIG. 6A. FIG. 6C is a plan view of the tapered slot antenna 6 viewed from the same direction as in FIG. 6A.

The coaxial connector 5 has a center conductor 51 to which the center conductor wire 21 of the coaxial line 2 is electrically connected, and an outer conductor 52 to which the outer conductor wire 23 of the coaxial line 2 is electrically connected. The outer conductor 52 has a cylindrical threaded portion 521, a pair of mounting pieces 522, 523, and a body 524 between the threaded portion 521 and the pair of mounting pieces 522, 523. The center conductor 51 and the outer conductor 52 are insulated by an insulator that is arranged inside the body 524. The pair of mounting pieces 522, 523 have threaded holes 522a, 523a respectively, into which the bolts 91, 92 are screwed.

The tapered slot antenna 6 is a planar antenna having a first element 61 and a second element 62 as antenna elements composed of flat plate conductors. The tapered slot antenna 6 and the waveguide member 7 are axially aligned. A tapered slot 60 is formed in a portion on a waveguide member 7-side of the tapered slot antenna 6, between the first element 61 and the second element 62. The distance between the first element 61 and the second element 62 in the portion where the slot 60 is formed gradually becomes wider toward the waveguide member 7.

A feeder line 63 is provided between the first element 61 and the second element 62 at the portion where the slot 60 is not formed. As shown in FIG. 6C, the feeder line 63 has a straight portion 631 extending along the axial direction between the first element 61 and the second element 62, and a connection line portion 632 connecting one end of the straight portion 631 on a slot 60-side with the first element 61. The other end of the straight portion 631 is connected to the center conductor 51 of the coaxial connector 5, e.g., by soldering. The distance between the straight portion 631 of the feeder line 63 and the first element 61 is wider near the connection line portion 632.

In the present embodiment, as shown in an enlarged view in FIG. 5B, the first element 61, the second element 62, and the feeder line 63 of the tapered slot antenna 6 are composed of a copper foil formed by etching on one side 64a of a base member (substrate) 64 made of a dielectric material such as FR4 (glass cloth impregnated with epoxy resin). In other words, the first element 61, the second element 62, and the feeder line 63 of the tapered slot antenna 6 are formed as a wiring pattern on the one side 64a of the base member 64 of the printed circuit board 600.

The other side 64b of the base member 64 is in contact with the first housing member 41. The first element 61 and the second element 62 of the tapered slot antenna 6 are in contact with the mounting pieces 522, 523 of the coaxial connector 5 and the second housing member 42. As a result, the first element 61 and the second element 62 are in electrical conductivity with the first and second housing members 41, 42 and the outer conductor 52 of the coaxial connector 5. A notch 410 is formed in the first housing member 41 around the back side (the other side 64b) of the feeder line 63, as shown in FIG. 5A. The tapered slot antenna 6 may be composed of a single layer of copper sheet, omitting the base member 64.

The printed circuit board 600 has through holes 601, 602 through which the bolts 91, 92 are inserted. The through holes 601, 602 penetrate the base member 64, the first element 61, and the second element 62 in their thickness direction. The bolts 91, 92 are inserted into bolt insertion holes 411, 412 formed in the first housing member 41 and the through holes 601, 602 in the printed circuit board 600, and screwed into the screw holes 522a, 523a of the pair of mounting pieces 522, 523 in the outer conductor 52 of the coaxial connector 5. The printed circuit board 600 is sandwiched between the pair of mounting pieces 522, 523 and the first housing member 41, with the first element 61 and the second element 62 contacting the mounting pieces 522, 523 respectively. This electrically connects the coaxial line 2 to the tapered slot antenna 6 via the coaxial connector 5.

The waveguide member 7 has a conical-shaped portion 71 at one end in the axial direction and a cylindrical-shaped portion 72 that is continuous with the conical-shaped portion 71 and aligned in the axial direction. The outer diameter of the cylindrical-shaped portion 72 is the same as the outer diameter of the end at the cylindrical-shaped portion 72 side of the conical-shaped portion 71. The central axis C₃ of the waveguide member 7 coincides with the central axis C₂ of the housing 4. FIGS. 4A and 4C show a conical surface 71a of a part in the axial direction of the conical-shaped portion 71 including a tip 711, as well as a cross-section of the conical-shaped portion 71 along the central axis C₃. At the center of the waveguide member 7, a center hole 70 is formed extending from an axial end face 72a on the opposite side of the conical-shaped portion 71 in the cylindrical-shaped portion 72 to the conical-shaped portion 71 along the central axis C₃.

The tapered slot antenna 6 is arranged to face the conical surface 71a, which is the outer circumference of the conical-shaped portion 71. Specifically, at least a part of the conical-shaped portion 71 is disposed in the slot 60 of the tapered slot antenna 6, and a part of the conical-shaped portion 71 including the tip 711 in the axial direction is disposed between an edge 61a at the slot 60 side in the first element 61 and an edge 62a at the slot 60 side in the second element 62. A first gap S1 is formed between the edge 61a at the slot 60 side in the first element 61 and the edge 62a at the slot 60 side in the second element 62 and the conical surface 71a of the conical-shaped portion 71.

The dielectric waveguide 3 is connected to the end opposite to the tapered slot antenna 6 in the waveguide member 7. The end face 32a of the plurality of dielectric waveguide wires 32 contacts the axial end face 72a of the cylindrical-shaped portion 72, and the dielectric waveguide tube 31 is inserted into the center hole 70 of the waveguide member 7. The plurality of dielectric waveguide wires 32 exposed from the jacket 3B are sandwiched between a pair of support members 8.

The pair of support members 8 contact a circumferential portion of the outer circumferential surface 7a of the waveguide member 7 to support the waveguide member 7 against the housing 4, as shown in FIG. 5D. In the present embodiment, the pair of support members 8 each contact a circumferential portion of the outer circumferential surface 7a in the cylindrical-shaped portion 72 of the waveguide member 7, and the cylindrical-shaped portion 72 is held between the pair of support members 8. A second gap S2 is formed between the other part of the circumferential direction of the outer circumferential surface 7a of the waveguide member 7, which the support members 8 do not contact, and an inner surface 4a of the housing 4. The second gap S₂ is in communication within the housing 4 with the first gap S₁ between the first and second elements 61, 62, and the conical-shaped portion 71. The first gap S₁ and the second gap S₂ are filled with air, for which the dielectric loss tangent is approximately 0.

The support members 8 integrally comprise a bent plate portion 81 interposed between the housing 4 and the cylindrical-shaped portion 72 of the waveguide member 7 and the plurality of dielectric waveguide wires 32 of the dielectric waveguide 3, and a flange portion 82 facing a shaft end surface 4b of the housing 4. The bent plate portion 81 is bent in an arc shape when viewed from the axial direction and has a concave bent surface 81a facing the outer circumferential surface 7a of the waveguide member 7 and a convex bent surface 81b facing the inner surface 4a of the housing 4. The pair of set screws 93, 94 contact the convex bent surface 81b of the support members 8 at one side and the other side, and when the pair of set screws 93, 94 are tightened, the concave bent surface 81a of the bent plate portion 81 is pressed against the outer circumferential surface 7a of the cylindrical-shaped portion 72 in the waveguide member 7. The axial position of the support members 8 with respect to the housing 4 is defined by the flange portion 82 contacting the shaft end surface 4b of the housing 4.

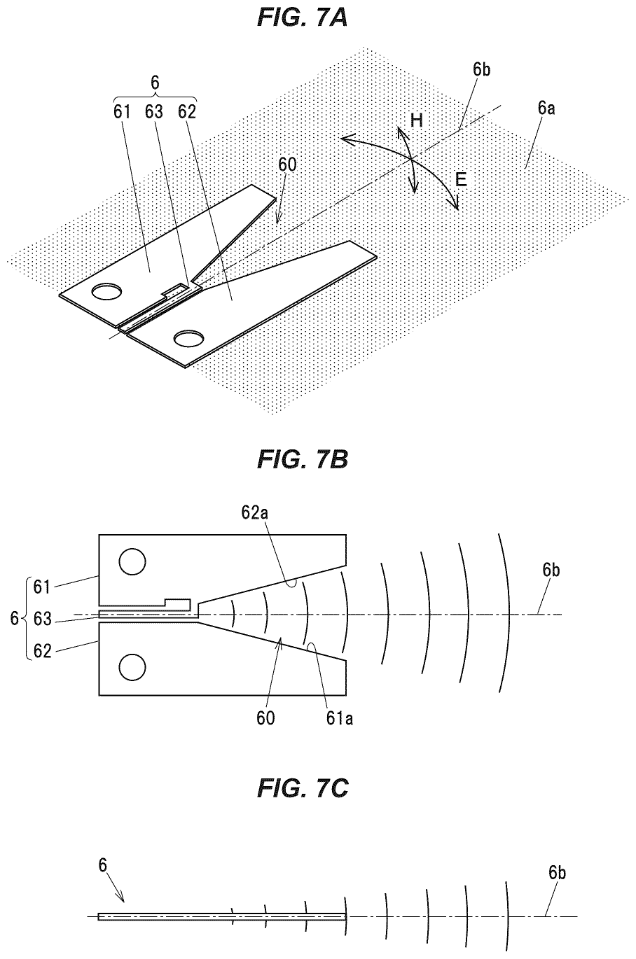

FIG. 7A is a perspective view of the tapered slot antenna 6. In FIG. 7A, a virtual plane 6a including the tapered slot antenna 6 is shown in gray, and a radiation axis 6b of the tapered slot antenna 6 is shown as a dashed-dotted line. The radiation axis 6b is a straight line perpendicular to the alignment direction of the first element 61 and the second element 62, and is included in the virtual plane 6a together with the first element 61 and the second element 62. The waveguide member 7 is supported so that the central axis C₃ is aligned with the radiation axis 6b. An E plane (electric field plane) of the tapered slot antenna 6 is included in the virtual plane 6a. An H plane (magnetic field plane) of the tapered slot antenna 6 is perpendicular to the virtual plane 6a.

FIGS. 7B and 7C are explanatory diagrams illustrating the electromagnetic waves radiated from the tapered slot antenna 6. FIG. 7B is a diagram viewed from a direction perpendicular to the virtual plane 6a and the tapered slot antenna 6, while FIG. 7C is a diagram viewed from a direction perpendicular to the radiation axis 6b and parallel to the virtual plane 6a. The electromagnetic waves radiated by the tapered slot antenna 6 is a traveling wave that travels toward the opening direction of the slot 60. A part of the wave propagates on the outer surface of the dielectric waveguide 3 through the outer circumferential surface 7a of the waveguide member 7, and the other part enters the waveguide member 7 and propagates through the cavity 310 of the dielectric waveguide tube 31 and the plurality of dielectric waveguide wires 32.

In FIG. 5D, the virtual plane 6a is shown as a dash-double-dotted line. As shown in FIG. 5D, the virtual plane 6a does not intersect the pair of support members 8. Also, the pair of support members 8 sandwich the waveguide member 7 in a direction perpendicular to the virtual plane 6a. This support structure of the waveguide member 7 makes it difficult for the surface waves propagating on the outer circumferential surface 7a of the waveguide member 7 to be blocked by the support members 8. In the direction perpendicular to the virtual plane 6a, the width W of a part where the respective support members 8 are in contact with the waveguide member 7 is 10% or less of an outer diameter D of the cylindrical-shaped portion 72, which is the outer diameter of the waveguide member 7 in the part where the support members 8 are in contact.

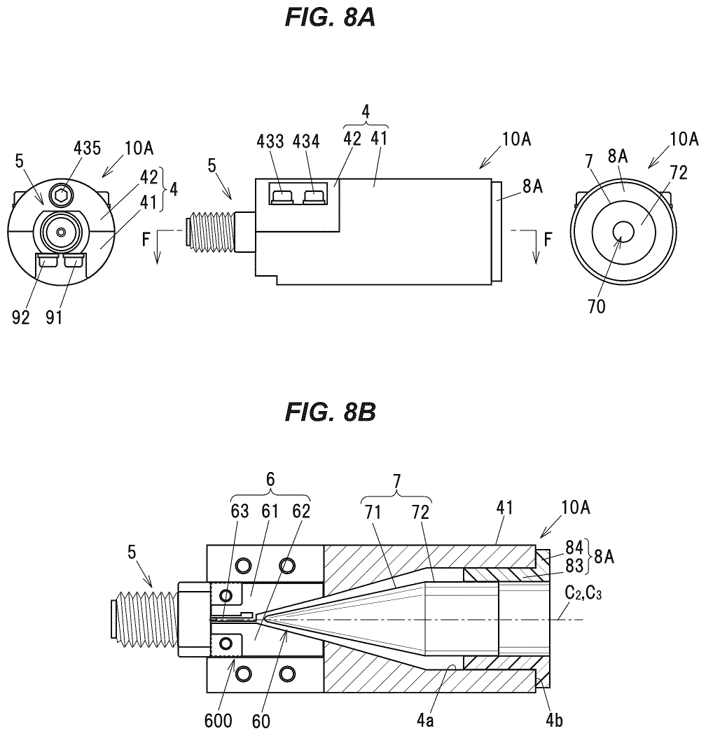

FIG. 8A is a three-sided view showing a configuration of a converter 10A according to a comparative example. FIG. 8B is a cross-sectional view of the converter 10A taken along the line F-F in FIG. 8A. The converter 10A has the housing 4, the coaxial connector 5, the tapered slot antenna 6, and the waveguide member 7 as in the converter 10 according to the above embodiment, but the shape of the support members 8A supporting the waveguide member 7 relative to the housing 4 is different from the support members 8 according to the above embodiment. The support members 8A are made of the same dielectric material as the support members 8, and have a cylindrical portion 83 that covers a portion of the cylindrical-shaped portion 72 of the waveguide member 7 in the axial direction over the entire circumference, and a circular flange portion 84 that faces the shaft end surface 4b of the housing 4.

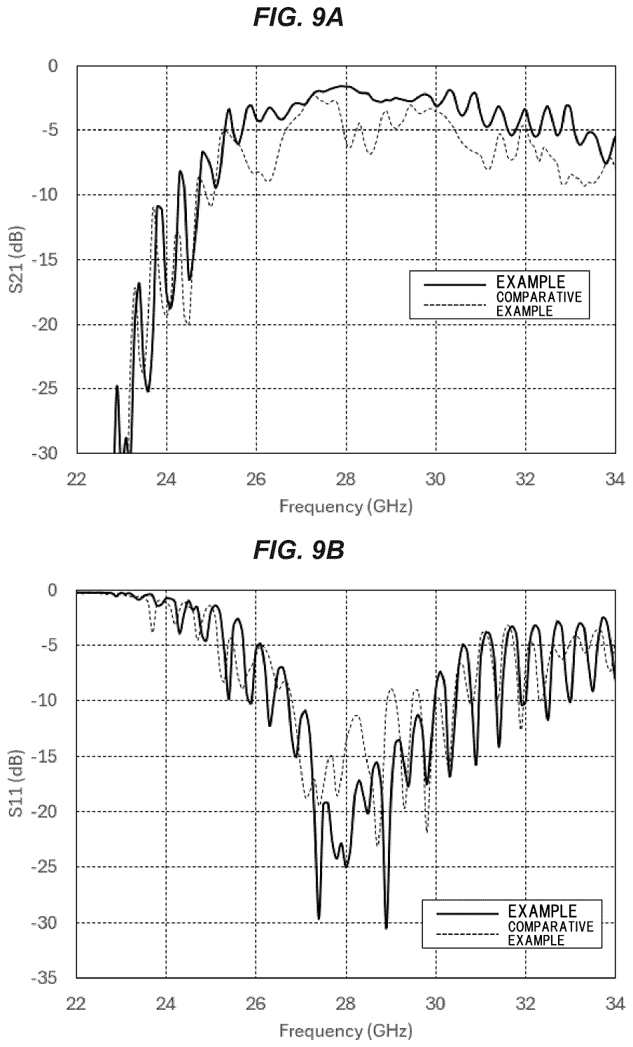

FIG. 9A is a graph showing the results of measuring S21 (transmission coefficient) of S-parameters for the case of using the converter 10 in Example according to the above embodiment and the case of using the converter 10A in the comparative example, respectively. FIG. 9B is a graph showing the results of measuring S11 (reflection coefficient) of S-parameters for the case of using the converter 10 in Example according to the above embodiment and the case of using the converter 10A in the comparative example, respectively. In FIGS. 9A and 9B, S21 and S11 are shown as solid lines when the converter 10 is used, while S21 and S11 are shown as dotted lines when the converter 10A is used.

As shown in FIG. 9A, when the converter 10 is used, S21 is generally higher than when the converter 10A is used, and good and high pass characteristics are obtained. Also, as shown in FIG. 9B, when the converter 10 is used, S11 is generally lower than when the converter 10A is used, which means that the reflection is suppressed. This proves that the second gap S2 that is formed between the pair of support members 8 supporting the waveguide member 7 in the converter 10 makes it difficult for the surface waves propagating on the outer circumferential surface 7a of the waveguide member 7 to be blocked by the support members 8. At the same time, it suppresses the reflection at the support members 8, improving the transmission characteristics of the transmission line 1.

In the frequency range shown in FIGS. 9A and 9B, particularly good transmission characteristics are obtained in the 28 GHz band (27.0 GHz to 29.5 GHZ).

### FUNCTIONS AND EFFECTS OF THE EMBODIMENT

According to the embodiment described above, it is possible to obtain the following effects (1) through (4).
(1) A gap is formed between a circumferential part of the outer circumferential surface 7a of the waveguide member 7, which the support members 8 do not contact, and the inner surface 4a of the housing 4, and therefore the dielectric waveguide 3 and the coaxial line 2 are coupled with low loss.
(2) Since the cylindrical-shaped portion 72 of the waveguide member 7 is sandwiched between the pair of support members 8, the waveguide member 7 can be supported against the housing 4 with high support rigidity and a gap can be provided between the pair of support members 8.
(3) The virtual plane 6a including the tapered slot antenna 6, which is a planar antenna, does not intersect with the pair of support members 8, and the pair of support members 8 sandwich the waveguide member 7 in a direction perpendicular to the virtual plane 6a, and therefore good passing characteristics can be obtained and reflections can be suppressed.
(4) By placing the conical-shaped portion 71 of the waveguide member 7 in the slot 60 of the tapered slot antenna 6, the distance between the first and second elements 61, 62 and the conical surface 71a of the conical-shaped portion 71 can be shortened. At the same time, the first and second elements 61, 62 and the conical surface 71a of the conical-shaped portion 71 can be facing each other over a long distance along the axial direction, thereby reducing losses.

### SUMMARY OF THE EMBODIMENT

Next, technical ideas understood from the above embodiment, will be described with reference to the reference numerals and the like used in the embodiment. However, each reference numeral in the following description does not limit the constituent elements in the scope of claims to the members and the like specifically shown in the embodiments.

According to the first feature, a converter 10 for electromagnetically coupling a dielectric waveguide 3 and a coaxial line 2 includes a shaft-shaped waveguide member 7 made of a dielectric having a conical-shaped portion 71 at one end in the axial direction; an antenna 6 arranged opposite a conical surface 71a of the conical-shaped portion 71; a housing 4 for housing the waveguide member 7 and the antenna 6; and a support member 8 for supporting the waveguide member 7 against the housing 4, wherein the coaxial line 2 is connected to the antenna 6, while the dielectric waveguide 3 is connected to the waveguide member 7, wherein the support member 8 supports the waveguide member 7 against the housing 4 by contacting one part of a circumferential portion of an outer circumferential surface 7a of the waveguide member 7, and wherein a gap S2 is formed between the other part of the circumferential portion of the outer circumferential surface 7a of the waveguide member 7, which the support member 8 does not contact, and an inner surface 4a of the housing 4.

According to the second feature, in the converter 10 as described by the first feature, the support member 8 includes a pair of support members 8, wherein the waveguide member 7 has a cylindrical-shaped portion 72 that is axially aligned in succession with the conical-shaped portion 71, and wherein the cylindrical-shaped portion 72 is sandwiched between the pair of support members 8.

According to the third feature, in the converter 10 as described by the first feature, the antenna 6 is a planar antenna having a flat antenna element 61, 62, and wherein a virtual plane 6a including the antenna 6 does not intersect the support member 8.

According to the fourth feature, in the converter 10 as described by the third feature, the support member comprises a pair of support members 8, wherein the pair of support members 8 sandwich the waveguide member 7 in a direction perpendicular to the virtual plane 6a.

According to the fifth feature, in the converter 10 as described by any of the first to fourth features, the antenna 6 is a tapered slot antenna having a first element 61 and a second element 62 each of which is composed of a flat plate conductor, and a tapered slot 60 formed between the first element 61 and the second element 62, and wherein at least a part of the conical-shaped portion 71 of the waveguide member 7 is placed in the tapered slot 60.

The above description of the embodiments of the present invention does not limit the invention to the scope of the claims. It should also be noted that not all of the combinations of features described in the embodiments are essential to solve the problems of the invention.

The present invention can be implemented with appropriate modifications to the extent that it does not depart from the intent of the invention. For example, in the above embodiment, the case in which the center hole 70 is formed in the waveguide member 7 is described, but the center hole 70 may not be formed in the waveguide member 7. In this case, the plurality of dielectric waveguide wires 32 may be arranged at the center of the dielectric waveguide 3 instead of the dielectric waveguide tube 31.

In the above embodiment, the case where the waveguide member 7 is sandwiched between a pair of support members 8 is described, but the support structure of the waveguide member 7 is not limited to this, but various support structures can be employed as long as a gap is formed between a circumferential part of the outer circumferential surface 7a of the waveguide member 7 and the inner surface 4a of the housing 4 that the support members 8 do not contact. Additionally, the support members 8 may be integrated with the waveguide member 7.

1. A converter for electromagnetically coupling a dielectric waveguide and a coaxial line, comprising:
a shaft-shaped waveguide member composed of a dielectric having a conical-shaped portion at one end in an axial direction;
an antenna arranged opposite a conical surface of the conical-shaped portion;
a housing for housing the waveguide member and the antenna; and
a support member for supporting the waveguide member against the housing,
wherein the coaxial line is connected to the antenna, while the dielectric waveguide is connected to the waveguide member,
wherein the support member supports the waveguide member against the housing by contacting one part of a circumferential portion of an outer circumferential surface of the waveguide member, and
wherein a gap is formed between an other part of a circumferential part of an outer circumferential surface of the waveguide member, which the support member does not contact, and an inner surface of the housing.

2. The converter, according to claim 1, wherein the support member comprises a pair of support members, wherein the waveguide member has a cylindrical-shaped portion that is axially aligned in succession with the conical-shaped portion, and wherein the cylindrical-shaped portion is sandwiched between the pair of support members.

3. The converter, according to claim 1, wherein the antenna is a planar antenna having a flat antenna element, and wherein a virtual plane including the antenna does not intersect the support member.

4. The converter, according to claim 3, wherein the support member comprises a pair of support members, wherein the pair of support members sandwich the waveguide member in a direction perpendicular to the virtual plane.

5. The converter, according to claim 1, wherein the antenna is a tapered slot antenna having a first element and a second element each of which is composed of a flat plate conductor, and a tapered slot formed between the first element and the second element, and wherein at least a part of the conical-shaped portion of the waveguide member is placed in the tapered slot.
